(19) United States
(12) Patent Application Publication
(10) Pub. No.: US 2006/0084421 A1
(43) Pub. Date: Apr. 20, 2006

(54) Universal remote control system

(76) Inventors: Kai Tai Lee, Hong Kong (HK); Kai Cheung Lee, Hong Kong (HK); Kai Man Lee, Hong Kong (HK)

Correspondence Address: Mr. Eric Chan, 42 Pin Oaks Drive, Phoenixville, PA, 19460, US

(21) Appl. No.: 10/967,787

(22) Filed: Oct. 19, 2004

(51) Int. Cl. H04M 3/00

(52) U.S. Cl. 455/420

(57) ABSTRACT

The present invention relates to a universal remote control system comprising a remote control means and one or more receiver modules installed in the device to be controlled by the remote control means. The remote control means includes an input means and a signal emitter means. The receiver module includes a signal receiver means, a command code database and a processor means. The user commands input via the input means are in the form of simple English language understandable by average users comprising alphanumeric characters.

### BACKGROUND OF THE INVENTION

The present invention relates to a remote control system and more particularly pertains to a universal remote control system which provides an user-friendly interface based on a human language for users to control various electrical appliances. In particular, the coding of the signals transmitted by the remote control means of the present invention is based on human language, especially English language.

There are different kinds of remote controls available in the marketplace. In general, a remote control system comprises a remote control and a corresponding remote control module installed in a device such as television, air conditioner and so forth. The remote control module receives control signals from the remote control to control the device to perform various functions. The remote control generally comprises a casing, a matrix of buttons, an encoder and a transmitter. The remote control module comprises a receiver, a decoder and an output unit. When the user presses a button on the remote control, the encoder processes the input and generates a corresponding signal of a particular frequency which can be transmitted on a wireless basis. The signal is usually in the form of device command code understandable by the device. The signal is then transmitted through the transmitter to the receiver of the remote control module. The signal is then decoded by the decoder into a pre-defined frequency and output to the corresponding part of the device through the output unit.

With the advancement in technology and the improvement in living standard, many households have a number of electrical appliances such as televisions, hi-fi sets, air conditioners, VCD/DVD players and so forth. Each of these appliances is usually provided with a remote control. Therefore, it is not uncommon to find three to four different remote controls in a living room. As most of the remote controls have similar appearances, users often find it confusing and troublesome to locate the right one to send control signals to the desired electrical appliance.

Moreover, with the increase in the number of functions provided by the electrical appliances nowadays, the number of buttons corresponding to these functions also increases. As such, a remote control usually has a matrix of many buttons. The positions and functions of these buttons are usually pre-defined by the manufacturer. Therefore, before the user can operate with the remote control, the user has to study the user manual and learn the function of each button. In other words, the user has to adapt to the design of the remote control. It may take a long time for the user to search for the right button in order to perform a certain function. Even for the same kind of electrical appliance, different models may provide different functions. So, the remote control for a certain model usually cannot be applicable to a different model. As a result, when the user changes or upgrades the appliance, the user will then have to study the user manual of the new remote control and take time to get used to it.

The introduction of universal remote controls helps to solve the aforementioned problems. However, the coding systems for the appliances of different manufacturers are usually different. For instance, the device command code for the volume up function for a television of Manufacturer A may be completely different from that of Manufacturer B. As the universal remote control is independent from the devices, the encoder has to be manually adapted to operate with different coding systems before it can transform the signals into a device command code which is understandable by the remote control modules of the devices. This process is usually troublesome and tiring.

Furthermore, the user interface of a universal remote control is generally a matrix of buttons. The number of buttons is fixed, and each button generally corresponds to one function. Therefore, if a user wishes to use the universal remote control for a number of different types of appliances, it may not be possible for the remote control to accommodate all these functions due to the limited number of buttons in the user interface.

### BRIEF SUMMARY OF THE INVENTION

In view of the aforesaid disadvantages now present in the prior art, the present invention provides a universal remote control system which provides an user-friendly interface based on a human language for users to control various electrical appliances. In contrast with the prior art, the present invention does not require the user to recite the user manual and learn the function of each key on the remote control before he can operate with the remote control. Instead, he can directly input user commands based on human language which is easy and quick to learn. Furthermore, the signal transmitted by the remote control means in the present invention is not in the form of device command codes which may vary with different manufacturers. Instead, the signal is coded directly from the human language user command code. As a result, the signals for various electrical appliances from different manufacturers can be standardized and thus users no longer need to manually adapt the encoder of the remote control means to operate with different electrical appliances.

To attain this, the present invention generally comprises: (a) remote control means which includes (i) input means for accepting human language user commands in text format comprising an address code component, a command code component and an end-of-command indicator which are input by users and generating the corresponding wirelessly transmittable signals comprising an address signal component and a command signal component, and (ii) signal emitter means for wirelessly transmitting the signals; (b) one or more receiver modules installed in the device to be controlled by the remote control means, each of the receiver modules includes (i) signal receiver means for storing one or more identification codes representing the device, detecting and receiving the signals emitted by the signal emitter means with the address signal component corresponding to one of the identification codes of the device, (ii) command code database for storing a pre-defined set of the command signal components and the corresponding function to be performed for each of the command signal components, wherein one or more different command signal components may correspond to the same function to be performed, and (iii) processor means for receiving the command signal component of the signal received by the signal receiver means, searching the command code database for the corresponding function to be performed, and controlling the function to be performed.

The address code component and the command code component of the user command are in the form of simple English language understandable by average users comprising alphanumeric characters and are preferably formed by one or two words; the signals generated by the input means are digital signals which are transformed from the human language user commands to their corresponding ASCII codes in binary forms.

The user command is in the form of <address code component, separator, command code component>, wherein the separator may take the form of “,”, “/”, “;” or any other non-alphanumeric characters as pre-defined.

The user command further comprises a security code component; the security code component will be transformed into a security signal component of the signal by the input means and the security signal component is transmitted by the signal emitter means together with the address signal component and the command signal component; the processor means of the receiver module is provided with a function for accepting or updating a device security code input via the remote control; the processor means will not control the device to perform any functions if the security signal component received by the signal receiver means does not correspond to the device security code.

The user command is in the form of <address code component, separator, security code component, separator, command code component>, wherein the separator may take the form of “,”, “/”, “;” or any other non-alphanumeric characters as pre-defined.

One or more function keys are provided on the input means and the activation of each function key represents the input of a pre-defined human language user command.

The processor means is able to control the device to output an error signal if the command signal component received by the signal receiver means does not correspond to any of the command signal components in the command code database.

The command signal component received by the signal receiver which does not correspond to any of the command signal components in the command code database is stored in the command code database and the corresponding function to be performed is initially defined to be “output an error signal”.

The command code database is editable and expandable so that users or manufacturers may add new command signal component in order to accommodate additional functions. For example, users may create short-cut commands to represent existing user commands and add the short-cut commands to the command code database.

The processor means of the receiver module is provided with a function for the user to update the identification code via the remote control so that users may choose an easy-to-remember name to identify the device.

The input means is a keyboard or a digitalizing tablet provided in a hand-held case.

The remote control means may be in the form of a mobile phone or personal digital assistant (PDA) provided with the hardware and software to transmit signals to the receiver modules.

It is an object of the present invention to provide a universal remote control system which has an user-friendly interface based on a human language for users to control various electrical appliances.

It is another object of the present invention to provide a remote control which can accommodate an unlimited number of appliances and an unlimited number of functions, so that it is possible to use only one remote control to control all the electrical appliances in a household.

It is a further object of the present invention to provide a remote control system which can use mobile phones, personal computers, PDAs and other electronic devices provided with signal emitter means to serve as remote controls.

An even further object of the present invention is to provide a remote control system which is susceptible of a low cost of manufacture with regard to both materials and labor, and which accordingly is then susceptible of low prices of sale to the consuming public, thus overcoming the disadvantages of the prior art.

### BRIEF DESCRIPTION OF THE DRAWINGS

FIG. 1 is a block diagram illustrating the present invention.

FIG. 2 is a table of a list of command code components with their corresponding ASCII codes for the hi-fi set.

FIG. 3 is a table of a list of further command code components with their corresponding ASCII codes for the hi-fi set.

FIG. 4 is a table of a list of further command code components with their corresponding ASCII codes for the DVD player.

FIG. 5 is a table of a list of further command code components with their corresponding ASCII codes for the television.

FIG. 6 is a table of a list of further command code components with their corresponding ASCII codes for the air conditioner.

### DETAILED DESCRIPTION OF THE INVENTION

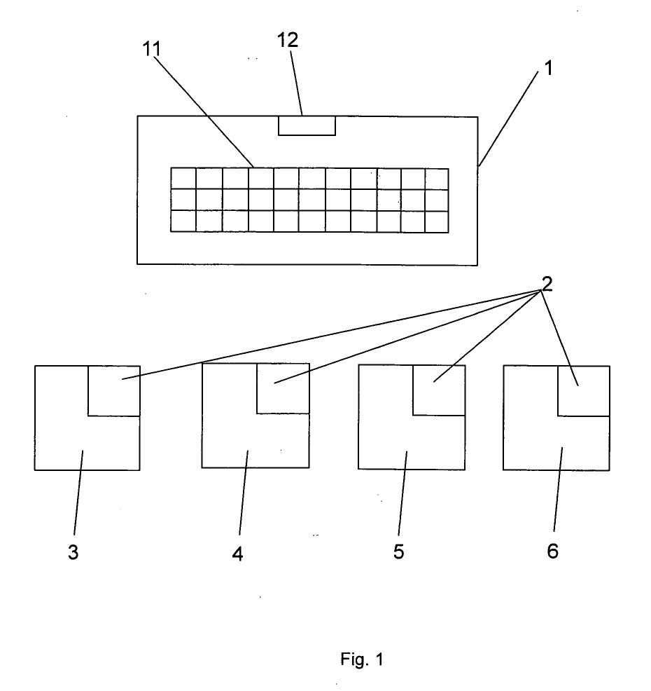

As illustrated in FIG. 1, an embodiment of the present invention generally comprises a remote control means 1 and four receiver modules 2 installed in four different devices to be controlled by the remote control means 1. The four devices are a television 3, a hi-fi set 4, a DVD player 5 and an air-conditioner 6.

The remote control means 1 in the present embodiment is a hand-held remote control equipped with a keyboard 11 which serves as an input means and an infra red transmitter 12 which serves as a signal emitter means. The keyboard 11 is similar to conventional keyboard for personal computers which is provided with keys for alphanumeric characters. The keyboard 11 is also provided with a “SEND” key and the pressing of the “SEND” key represents an end-of-command indicator. In other embodiments, the remote control means 1 may be in the form of a mobile phone or PDA provided with the hardware and software to transmit signals to the receiver modules 2. The keyboard 11 accepts human language user commands in text format comprising an address code component, a command code component and an end-of-command indicator which are input by users and generates the corresponding wirelessly transmittable signals comprising an address signal component and a command signal component. The infra red transmitter 12 is used for wirelessly transmitting the signals.

Each of the receiver modules 2 includes a signal receiver means 21, a command code database 22 and a processor means 23. The signal receiver means 21 stores one or more identification codes which represent the device. It also detects and receives the signals emitted by the infra red transmitter 12 with the address signal component corresponding to one of the identification codes of the device. The command code database 22 stores a pre-defined set of the command signal components and the corresponding function of each of the command signal components to be performed. The processor means 23 receives the command signal component of the signals from the signal receiver means 21, searches the command code database 22 for the corresponding functions to be performed, and controls the functions to be performed.

The address code component and the command code component of the user command are in the form of simple English language understandable by average users and comprise alphanumeric characters. Preferably, the address code component and the command code component are formed by one or two words. In the present embodiment, the user command is in the form of <address code component, command code component>. The “,” acts as a separator between different components to facilitate the device to detect the signals with the address signal component corresponding to its identification code. In other embodiments, the separator may take the form of “;”, “/” or other non-alphanumeric characters. The signals generated by the keyboard 11 are digital signals which are transformed from the human language user commands to their corresponding ASCII codes in binary forms.

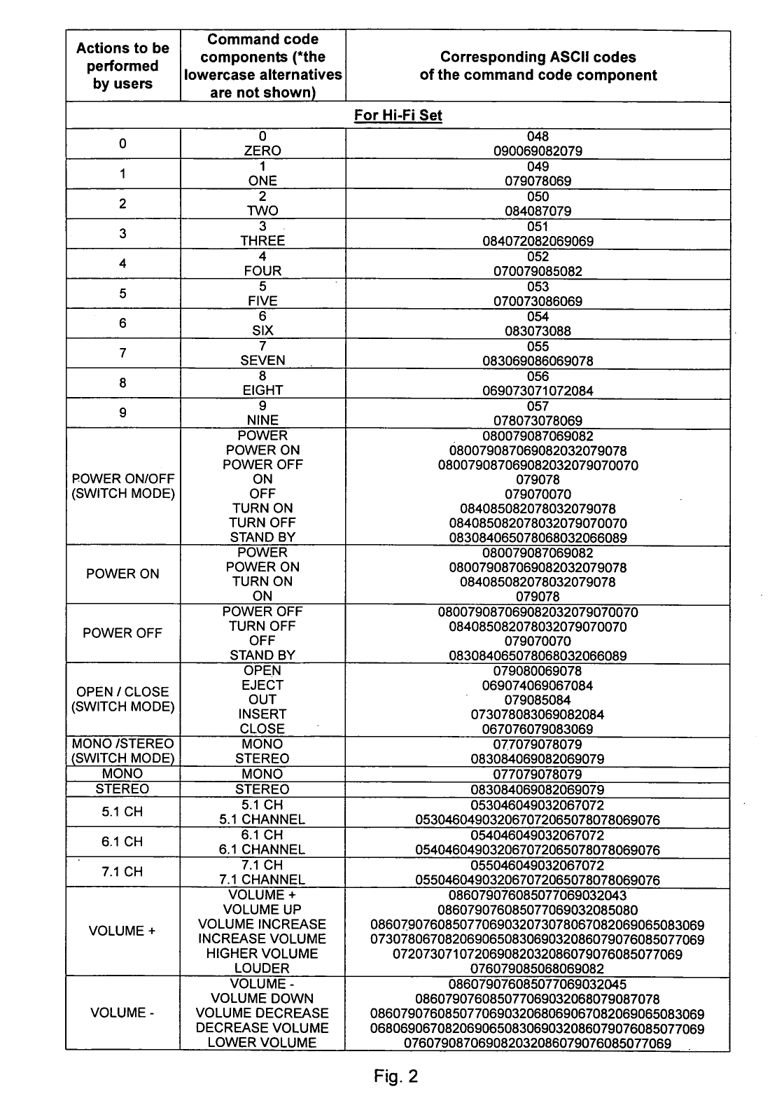

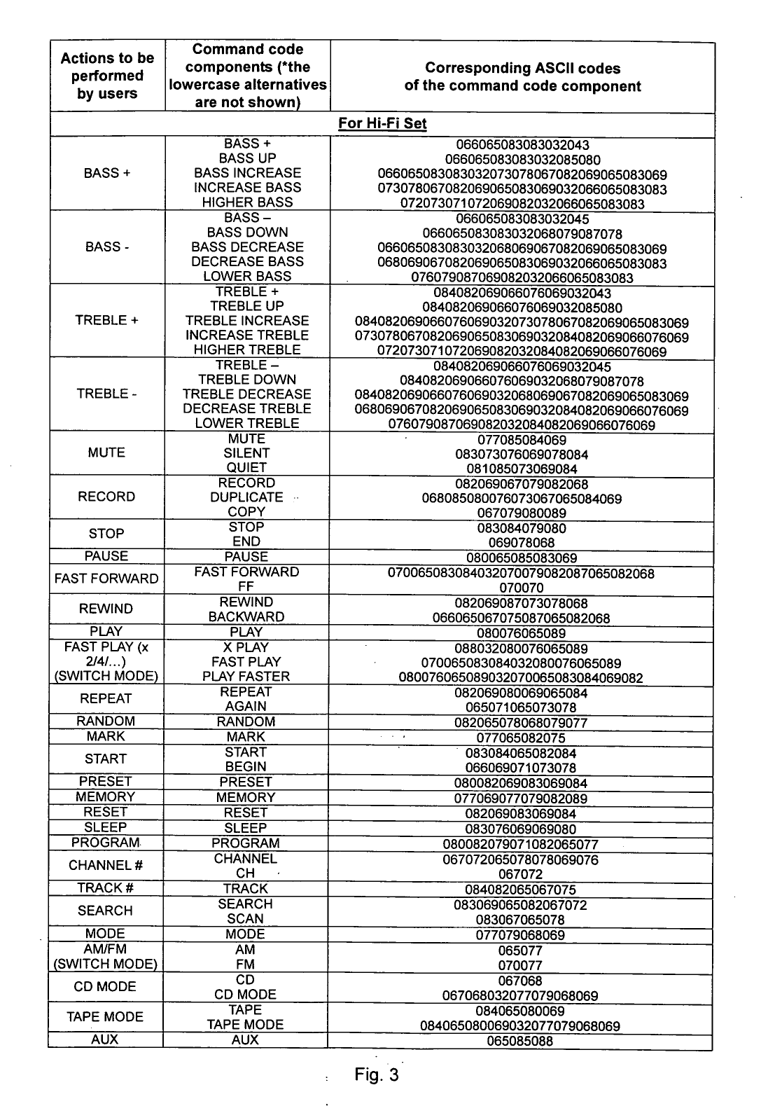

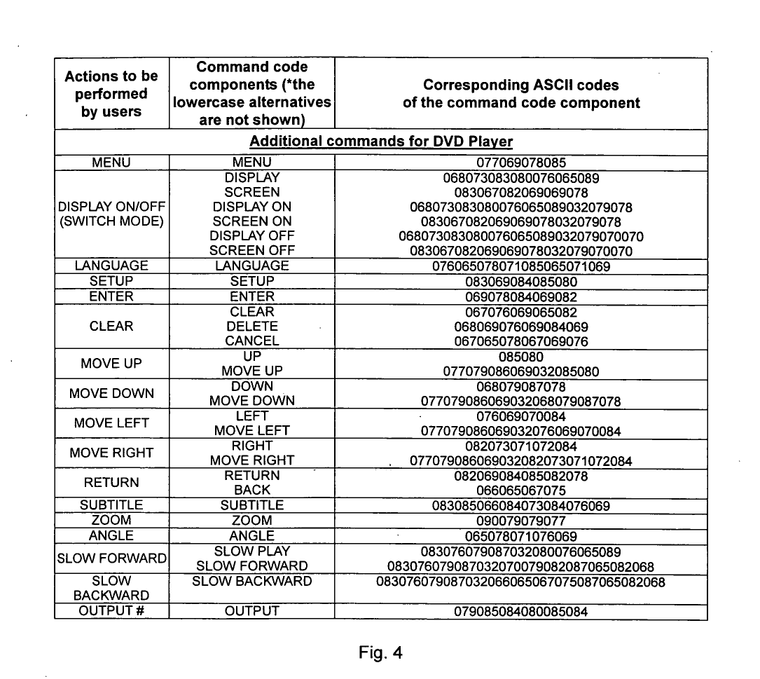

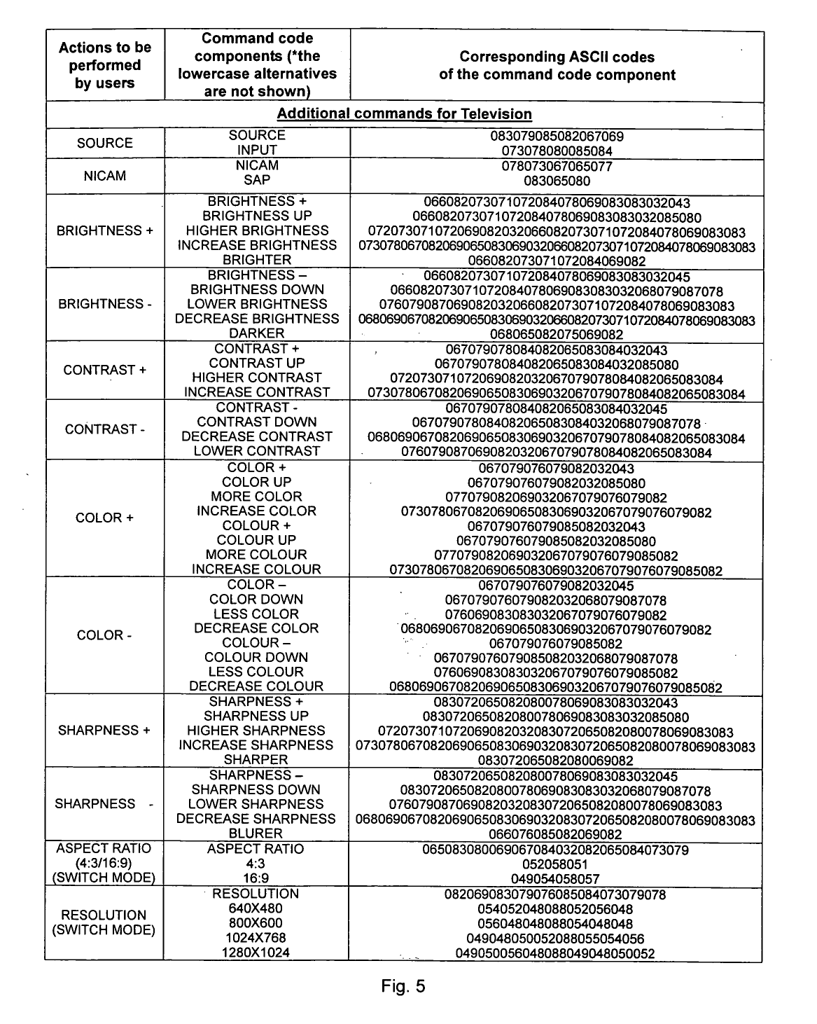

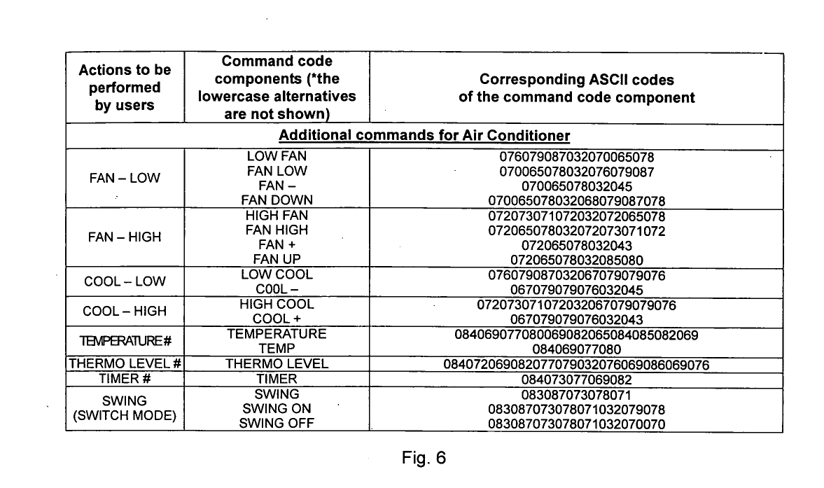

For instance, the address code components for the television 3, the hi-fi set 4, the DVD player 5 and the air-conditioner 6 in the present embodiment are “MY TV”, “MY HIFI”, “MY DVD” and “MY AIR” respectively; accordingly, the ASCII codes for the address code components are “077089032084086”, “077089032072073070073”, “077089032068086068” and “077089032065073082” respectively. The ASCII codes will then be transformed into their binary form for transmission. The same command code component may be applicable for more than one appliances. For example, the command code components for switching on the television 3, the hi-fi set 4, the-DVD player 5 and the air-conditioner 6 are “SWITCH ON”, “POWER ON”, “OPEN”, “ON” or “TURN ON”. On the other hand, a command code component may be applicable for one appliance only. For example, the command code component for switching to hi-cool mode for the air-conditioner 6 may be “HI COOL”. In other words, the command code component “HI COOL” will have no effect on the other three appliances. To increase the flexibility of the system, the command signal component for each of the lowercase alternatives of the command code components is also stored in the command code database 22. FIGS. 2 to 6 are tables of the list of command code components with their corresponding ASCII codes for the hi-fi set 4, the DVD player 5, the television 3 and the air-conditioner 6. For the sake of simplicity, the lowercase alternatives of the command code components are omitted in the table. However, in practice the lowercase alternatives of the command code component are also stored in the command code database.

If a user wishes to switch on the television 3, the user first inputs via the keyboard 11 the address code component for the television, i.e. “MY TV”. The user then inputs the separator “,” and the command code component “SWITCH ON” or “POWER ON” or “OPEN” or “ON” or “TURN ON”. An example of the user command would be “MY TV,ON”. After the user finishes inputting the user command, the user presses the “SEND” button on the keyboard 11. The keyboard 11 then transforms the user command into its ASCII code equivalent, which is “077089032084086” for the address code component and “079078” for the command code component. The ASCII codes are then transformed into their binary form and transmitted through the infra red transmitter 12 as a signal comprising the address signal component and the command signal component. The signal receiver means 21 of television 3 detects that the address signal component of the signal is identical to one of its identification codes. Therefore, the signal receiver means 21 receives the signal. The processor means 23 then searches for the command code database 22 for the command signal component and determines and controls the corresponding function to be performed.

In a further embodiment, special function keys such as “TV POWER”, “VOLUME UP”, “VOLUME DOWN” and so forth can be provided on the keyboard 11 to facilitate quicker input. The activation of each function key represents the input of a pre-defined human language user command. For example, the activation of the function key “TV POWER” represents the input of the user command <MY TV,ON> followed by the end-of-command indicator. The keyboard 11 will then generate and transmit the corresponding signal component of the command component <MY TV,ON>.

If the user inputs an invalid command code component and the command signal component thereof does not correspond to any of the command signal component in the command code database 22 of the device, the processor means 23 then controls the device to output an error signal. For example, the user inputs “MY TV OW”. The signal receiver means 21 of the television 3 receives the signal as the address signal component of the address code component “MY TV” is identical to the identification code of the television 3. However, the command signal component of the command code component “OW” does not correspond to any of the command signal components in the command code database of the television 3. As a result, the processor means 23 of the television 3 outputs an error signal. In this example, the error signal is the flashing of an LED status light on the front panel of the television 3. At the same time, the command signal component “OW” is stored in the command code database and the corresponding function to be performed is initially defined to be “output an error signal”. In the future, users or manufacturers may edit the corresponding function to be performed in the command code database.

The command code database is editable and expandable so that users or manufacturers may add new command signal components in order to accommodate additional functions. For example, users or manufacturers may add short-cut commands to the command code database to facilitate quicker input. The processor means 23 is provided with a function for the user to update the identification code via the remote control so that users may choose an easy-to-remember name to identify the device.

In a second embodiment of the present invention, the basic structure is the same as the first embodiment as illustrated in FIG. 1, but the user command further comprises a security code component. The provision of the securing code component is important in some situations as there may be a need to restrict the use of remote control to specific personnel. For example, for a television provided in a classroom of a primary school, the use of the remote control to control the television should be restricted to the teaching staff only. In this case, the receiver module 2 is provided with a function for accepting or updating the device securing code input by the user via the remote control. In this case, the user command is in the form of <address code component, security code component, command code component>, wherein “,” serves as a separator between different components. The security code component in this embodiment is a password comprising three alphanumerals. For instance, when a user wishes to switch on the television 3, the user command is “MY TV 456 ON”. The signal receiver means of the television 3 will then detect and receive the signal as the address signal component of “MY TV” corresponds to the identification code of the television 3. The processor means 23 will then determine if the security signal component of the signal corresponds to the security device code. If yes, the processor means 23 will continue to function; otherwise, the processor means 23 will output an error signal.

As user commands are in the form of English language, users no longer need to search for the right button among the matrix of buttons on the remote control. Instead, the user only needs to input the command via the remote control. The human language based user commands are easy to learn and remember, therefore users could quickly get used to the remote control.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. A universal remote control system comprising
(a) remote control means which includes
(i) input means for accepting human language user commands in text format comprising an address code component, a command code component and an end-of-command indicator which are input by users and generating the corresponding wirelessly transmittable signals comprising an address signal component and a command signal component; and
(ii) signal emitter means for wirelessly transmitting the signals;
(b) one or more receiver modules installed in the device to be controlled by the remote control means, each of the receiver modules includes
(i) signal receiver means for storing one or more identification codes representing the device, detecting and receiving the signals emitted by the signal emitter means with the address signal component corresponding to one of the identification codes of the device;
(ii) command code database for storing a pre-defined set of the command signal components and the corresponding function to be performed for each of the command signal components, wherein one or more different command signal components may correspond to the same function to be performed;
(iii) processor means for receiving the command signal component of the signal received by the signal receiver means, searching the command code database for the corresponding function to be performed, and controlling the function to be performed.

2. A universal remote control system as in claim 1, wherein the address code component and the command code component of the user command are in the form of simple English language understandable by average users comprising alphanumeric characters and are preferably formed by one or two words; the signals generated by the input means are digital signals which are transformed from the human language user commands to their corresponding ASCII codes in binary forms.

3. A universal remote control system as in claim 1, wherein the user command is in the form of <address code component, separator, command code component>, wherein the separator may take the form of “,”, “/”, “;” or any other non-alphanumeric characters as pre-defined.

4. A universal remote control system as in claim 1, wherein the user command further comprises a security code component; the security code component will be transformed into a security signal component of the signal by the input means and the security signal component is transmitted by the signal emitter means together with the address signal component and the command signal component; the processor means of the receiver module is provided with a function for accepting or updating a device security code input via the remote control; the processor means will not control the device to perform any functions if the security signal component received by the signal receiver means does not correspond to the device security code.

5. A universal remote control system as in claims 1 or 4, wherein the user command is in the form of <address code component, separator, security code component, separator, command code component>, wherein the separator may take the form of “,”, “/”, “;” or any other non-alphanumeric characters as pre-defined.

6. A universal remote control system as in claim 1, wherein one or more function keys are provided on the input means and the activation of each function key represents the input of a predefined human language user command.

7. A universal remote control system as in claim 1, wherein the processor means is able to control the device to output an error signal if the command signal component received by the signal receiver means does not correspond to any of the command signal components in the command code database.

8. A universal remote control system as in claim 7, wherein the command signal component received by the signal receiver which does not correspond to any of the command signal components in the command code database is stored in the command code database and the corresponding function to be performed thereof is initially defined to be “output an error signal”.

9. A universal remote control system as in claim 1, wherein the command code database is editable and expandable so that users or manufacturers may add new command signal component in order to accommodate additional functions.

10. A universal remote control system as in claim 1, wherein the processor means of the receiver module is provided with a function for the user to update the identification code via the remote control so that users may choose an easy-to-remember name to identify the device.

11. A universal remote control system as in claim 1, wherein the input means is a keyboard or a digitalizing tablet provided in a hand-held case.

12. A universal remote control system as in claim 1, wherein the remote control means may be in the form of a mobile phone or personal digital assistant (PDA) provided with the hardware and software to transmit signals to the receiver modules.
